(19) United States
(12) Patent Application Publication
(10) Pub. No.: US 2015/0106057 A1
(43) Pub. Date: Apr. 16, 2015

(54) PROFILE MEASUREMENT SYSTEM AND PROFILE MEASUREMENT METHOD

(71) Applicant: Otsuka Electronics Co., Ltd., Osaka (JP)

(72) Inventors: Kazuhiro SUGITA, Osaka (JP); Tomohiro AKADA, Osaka (JP)

(73) Assignee: Otsuka Electronics Co., Ltd.

(21) Appl. No.: 14/511,159

(22) Filed: Oct. 9, 2014

(30) Foreign Application Priority Data
Oct. 11, 2013 (JP) 2013-213455

(51) Int. Cl. G01B 11/24; G01B 11/14; G01J 3/28

(52) U.S. Cl. CPC G01B 11/24; G01J 3/2823; G01B 11/14
USPC 702/167

(57) ABSTRACT

Provided are a profile measurement system and a profile measurement method capable of suppressing the influence of vibration with a simple configuration. The profile measurement system includes: a transmissive optical component having a reference plane opposed to a surface of a sample; a light source which irradiates the surface of the sample with light having a predetermined wavelength region through the transmissive optical component; an imaging spectrometer which measures a reflection spectrum for each position on a linear region defined on the surface of the sample; and a calculation unit which calculates a distance between each position on the linear region and the reference plane based on the measured reflection spectrum for each position on the linear region.

### INCORPORATION BY REFERENCE

The present disclosure contains subject matter related to that disclosed in Japanese Priority Patent Application JP2013-213455 filed in the Japan Patent Office on Oct. 11, 2013, the entire contents of which are hereby incorporated by reference.

### BACKGROUND OF THE INVENTION

1. Field of the Invention

The present application relates to a profile measurement system and a profile measurement method.

2. Description of the Related Art

In Japanese Patent Application Laid-open No. 2013-24734, there is disclosed a related art utilizing the principle of a Michelson interferometer, in which reflection spectra of white light radiated to a surface to be detected and a reference surface are imaged in one shot by an imaging spectrometer (spectrometer and two-dimensional imaging element) to analyze an uneven shape of the surface to be detected.

By the way, in the related art, an optical path between abeam splitter and the surface to be detected and an optical path between the beam splitter and the reference surface need to be maintained constant. However, those optical paths are relatively long, resulting in a problem in that the optical paths are susceptible to the influence of vibration. In order to eliminate the influence of vibration, a large-scale anti-vibration facility is necessary.

In the technical field of through-silicon via (TSV), a hole having a relatively large aspect ratio (ratio of depth to hole diameter) is formed in a semiconductor chip. When the profile of such hole is to be measured, there is another problem in that the measurement is difficult because light is hard to reach the bottom of the hole due to the influence of vibration.

The present application has been made in view of the above-mentioned problems, and it is an object thereof to provide a profile measurement system and a profile measurement method capable of suppressing the influence of vibration with a simple configuration.

### SUMMARY OF THE INVENTION

In order to solve the above-mentioned problems, according to one embodiment of the present application, there is provided a profile measurement system, including: a transmissive optical component having a reference plane opposed to a surface of a sample; a light source which irradiates the surface of the sample with light having a predetermined wavelength region through the transmissive optical component; an imaging spectrometer which measures a reflection spectrum for each position on a linear region defined on the surface of the sample; and a calculation unit which calculates a distance between each position on the linear region and the reference plane based on the measured reflection spectrum for each position on the linear region.

Further, according to another embodiment of the present application, there is provided a profile measurement method, including: irradiating a surface of a sample with light having a predetermined wavelength region through a transmissive optical component having a reference plane to be opposed to the surface of the sample; measuring, by an imaging spectrometer, a reflection spectrum for each position on a linear region defined on the surface of the sample; and calculating a distance between each position on the linear region and the reference plane based on the measured reflection spectrum for each position on the linear region.

### BRIEF DESCRIPTION OF THE DRAWINGS

FIG. 1 is a diagram illustrating an example of optical and electrical configurations of a profile measurement system according to an embodiment of the present application.

FIG. 2 is a top view illustrating an example of a sample.

FIG. 3 is a cross-sectional view illustrating an example of the sample.

FIG. 4 is a flowchart illustrating an example of a measurement procedure.

FIG. 5 is a graph showing an example of the spectrum of reflectance.

FIG. 6 is a graph showing an example of an analysis result by FFT.

FIG. 7 is a diagram illustrating an example of a mechanical configuration of the profile measurement system.

FIG. 8 is a diagram illustrating another example of the mechanical configuration of the profile measurement system.

FIG. 9 is a cross-sectional view illustrating another example of the sample.

FIG. 10 is a flowchart illustrating another example of the measurement procedure.

FIGS. 11A and 11B are graphs showing other examples of the spectrum of reflectance.

FIG. 12 is a graph showing another example of the analysis result by FFT.

### DETAILED DESCRIPTION OF THE INVENTION

One embodiment of the present application is now described with reference to the attached drawings.

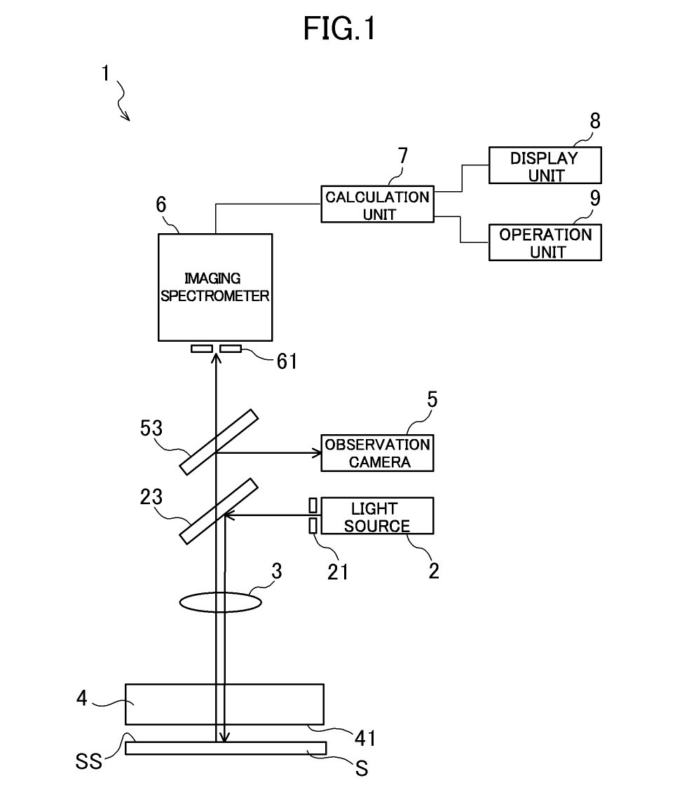

FIG. 1 is a diagram illustrating an example of optical and electrical configurations of a profile measurement system 1 according to the embodiment of the present application. In the following description, a direction in which an optical component 4 is arranged with respect to a sample S is an upward direction, and a direction in which the sample S is arranged with respect to the optical component 4 is a downward direction.

The profile measurement system 1 includes a light source 2 for generating light to irradiate a surface SS of the sample S, an objective lens 3 for focusing the light onto the surface SS of the sample S, a transmissive optical component 4 arranged between the objective lens 3 and the sample S, an observation camera 5 for observing the surface SS of the sample S, and an imaging spectrometer 6 for measuring the spectrum of light reflected from the optical component 4 and the sample S.

The profile measurement system 1 further includes a calculation unit 7 including a central processing unit (CPU) and the like, a display unit 8 such as a flat panel display (FPD), and an operation unit 9 such as a keyboard and a mouse. A known personal computer may be used for the calculation unit 7, the display unit 8, and the operation unit 9.

A white light source having flat output characteristics in a wide wavelength region is suitable as the light source 2, and a deuterium lamp, a tungsten lamp, or other such lamps may be employed. Light emitted from the light source 2 is shaped into linear light by a slit 21, which is an example of a field stop, and is then directed to the objective lens 3 through a half mirror 23.

The optical component 4 is made of a transmissive material, such as glass and quartz, and has a reference plane 41 to be opposed in proximity to the surface SS of the sample S. Part of light that has entered the optical component 4 from the objective lens 3 is reflected by the reference plane 41, and the remaining part is transmitted through the reference plane 41 and reflected by the surface SS of the sample S.

The light reflected by the reference plane 41 of the optical component 4 and the light reflected by the surface SS of the sample S reach the imaging spectrometer 6 through the optical component 4, the objective lens 3, and the half mirrors 23 and 51.

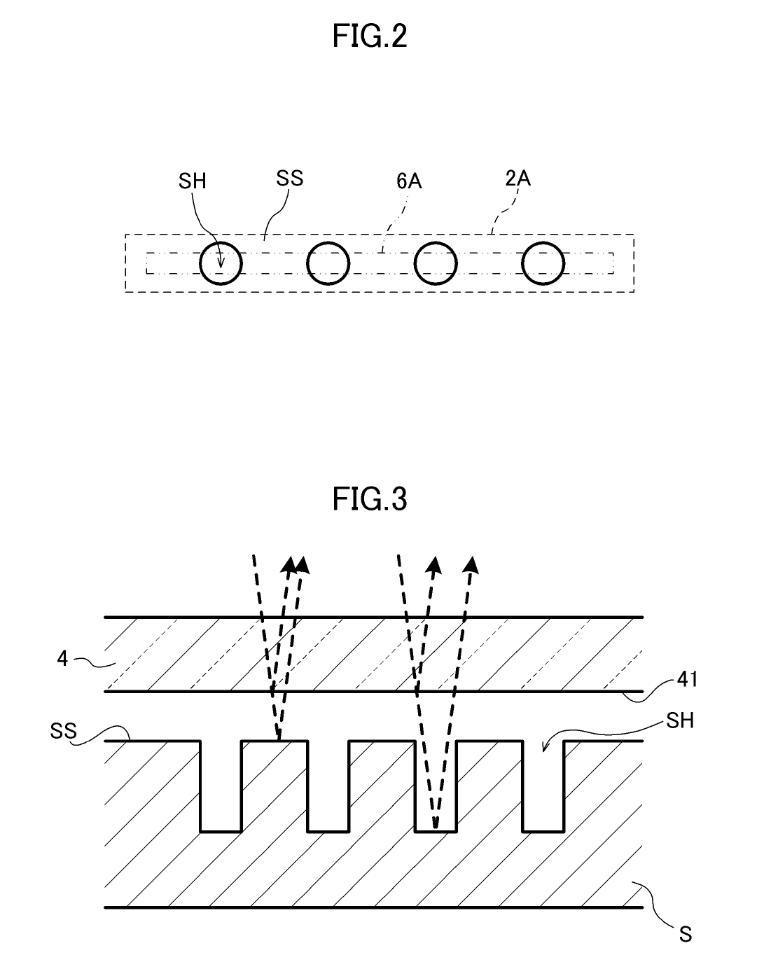

The imaging spectrometer 6 measures the spectrum of light reflected from the optical component 4 and the sample S, and outputs the result of measurement to the calculation unit 7. The light reflected from the optical component 4 and the sample S is shaped into linear light by a slit 61, and then enters the imaging spectrometer 6. In other words, the imaging spectrometer 6 receives light reflected by linear regions that are respectively defined for the reference plane 41 of the optical component 4 and the surface SS of the sample S. Details are described later with reference to FIG. 2.

Specifically, the imaging spectrometer 6 includes a spectrometer (not shown) and a two-dimensional imaging element (not shown), and light diffracted by the spectrometer in the width direction of the slit 61 is received by the two-dimensional imaging element. Accordingly, the width direction of the slit 61 corresponds to the direction of wavelength resolution, and the longitudinal direction of the slit 61 corresponds to the direction of spatial resolution.

Note that, the optical system for guiding light from the light source 2 to the optical component 4 and the optical system for guiding light from the optical component 4 to the imaging spectrometer 6 are not limited to the above-mentioned configurations, and it should be understood that various kinds of optical systems may be employed.

FIGS. 2 and 3 are a top view and a cross-sectional view illustrating an example of the sample S. In the sample S, a plurality of holes SH are formed to be open upward.

The sample S is, for example, a semiconductor chip to be used for through-silicon via (TSV), which has a hole having a relatively large aspect ratio formed therein. For example, the hole has a hole diameter of approximately 5 μm to approximately 10 μm, and a depth of approximately 100 μm at most. The hole formed in an upper surface of the semiconductor chip is filled with a conductor, and thereafter a lower surface of the semiconductor chip is polished until the conductor is exposed, to thereby complete the TSV.

As illustrated in FIG. 2, a linear irradiation region 2A to be irradiated with light from the light source 2 and a linear light receiving region 6A from which reflected light is received by the imaging spectrometer 6 are formed on the surface SS of the sample S so as to be overlapped with each other. The contour of the irradiation region 2A is formed by the slit 21 provided for the light source 2, and the contour of the light receiving region 6A is formed by the slit 61 provided for the imaging spectrometer 6. The slits 21 and 61 are arranged so that the longitudinal direction of the irradiation region 2A and the longitudinal direction of the light receiving region 6A are aligned with each other.

For example, the width of the light receiving region 6A is set to be smaller than the hole diameter of the hole SH of the sample S, and the length of the light receiving region 6A is set so as to include a plurality of the holes SH of the sample S. For example, the length and width of the irradiation region 2A are set so as to include the entire light receiving region 6A. By limiting the irradiation region 2A in this manner, light at the periphery of the light receiving region 6A is prevented from being easily contained as stray light. Without being limited to this configuration, the entire irradiation region 2A may be included in the light receiving region 6A.

As illustrated in FIG. 3, at a certain position on the light receiving region 6A in the longitudinal direction, light that has been transmitted through the reference plane 41 of the optical component 4 is reflected by the periphery of the hole SH, which is closest to the reference plane 41 among regions of the surface SS of the sample S, and interferes with light reflected by the reference plane 41 of the optical component 4. At another position on the light receiving region 6A in the longitudinal direction, light that has been transmitted through the reference plane 41 of the optical component 4 is reflected by the bottom surface of the hole SH, which is farthest from the reference plane 41 among the regions of the surface SS of the sample S, and interferes with light reflected by the reference plane 41 of the optical component 4.

The imaging spectrometer 6 is configured so that the direction of spatial resolution is the longitudinal direction of the slit 61 that forms the light receiving region 6A, and the direction of waveform resolution is the width direction thereof. Thus, the spectra of reflected light beams at respective positions on the linear light receiving region 6A in the longitudinal direction can be measured in one shot. In addition, by moving the sample S in a direction orthogonal to the longitudinal direction of the light receiving region 6A and measuring the spectra of reflected light beams at respective positions in the orthogonal direction, the spectra over a two-dimensional region can be measured.

Returning to the description of FIG. 1, the calculation unit 7 divides the spectrum of reflected light output from the imaging spectrometer 6 by a known spectrum of incident light, to thereby calculate the spectrum of reflectance. Then, based on the calculated reflectance spectrum, the calculation unit 7 calculates a distance between each position on the light receiving region 6A in the longitudinal direction and the reference plane 41.

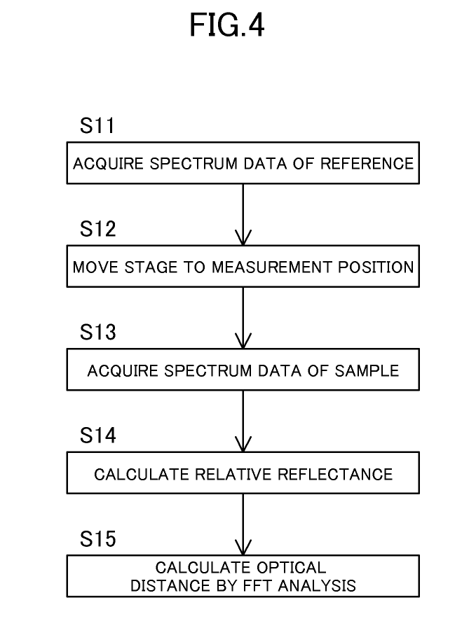

FIG. 4 is a flowchart illustrating an example of a measurement procedure. First, spectrum data of a reference is acquired (S11). Specifically, the light source 2 irradiates the reference with white light, and the imaging spectrometer 6 measures its reflection spectrum. In this manner, the calculation unit 7 acquires the spectrum data of the reference. For example, a plane mirror made of aluminum or the like is suitable as the reference.

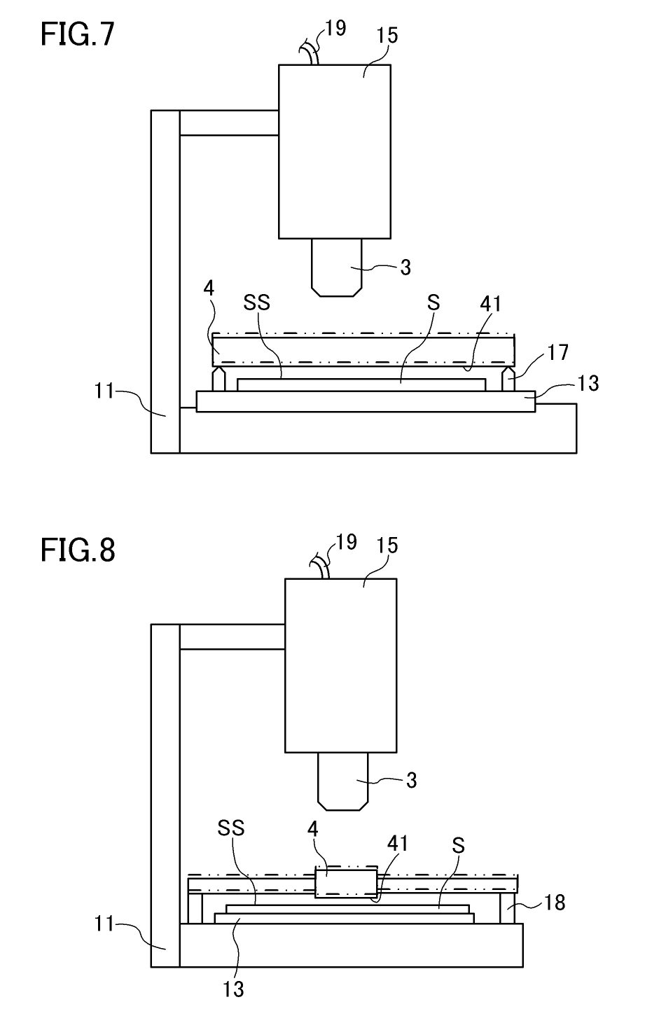

Next, the stage is moved to a measurement position (S12). Specifically, the calculation unit 7 moves an XY stage 13 (see FIGS. 7 and 8) having the sample S arranged thereon, which is described later, so that the sample S may be positioned at a predetermined measurement position.

Next, spectrum data of the sample S is acquired (S13). Specifically, the light source 2 irradiates the sample S with white light, and the imaging spectrometer 6 measures its reflection spectrum. In this manner, the calculation unit 7 acquires the spectrum data of the sample S.

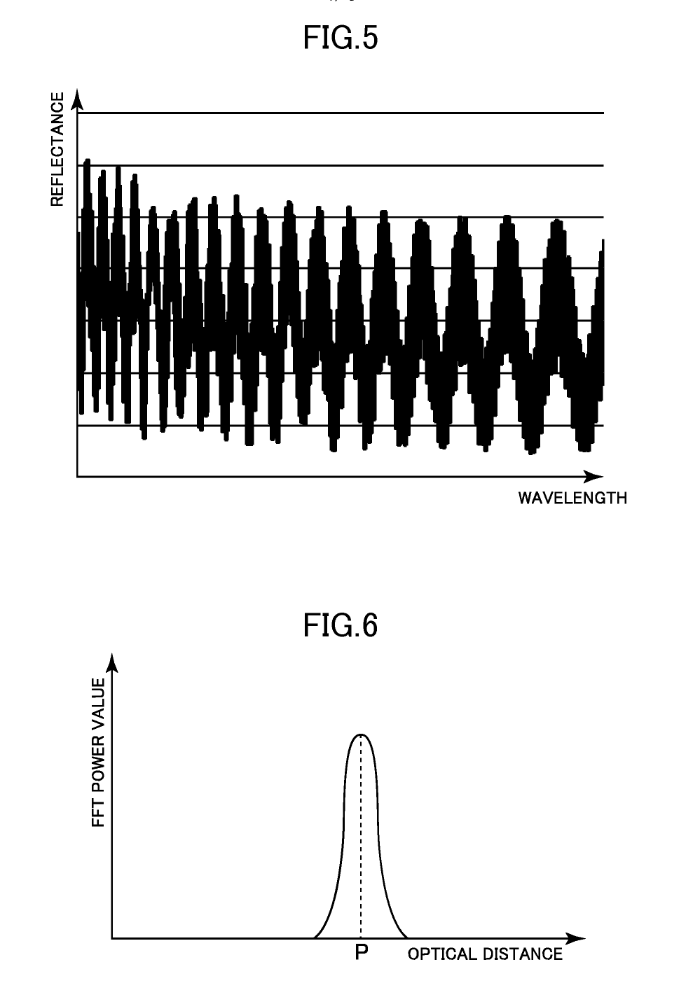

Next, a relative reflectance of the sample S is calculated (S14). Specifically, the calculation unit 7 divides the spectrum of light reflected from the sample S by the spectrum of light reflected from the reference, to thereby calculate the spectrum of reflectance. FIG. 5 is a graph showing an example of the spectrum of reflectance.

After that, an optical distance is calculated by FFT analysis (S15). Specifically, the calculation unit 7 calculates a curve of an FFT power value based on the spectrum of reflectance, and calculates an optical distance based on a peak thereof. FIG. 6 is a graph showing an example of an analysis result by FFT.

In this manner, an optical distance between the reference plane 41 of the optical component 4 and the surface SS of the sample S can be obtained, and further, by dividing the optical distance by the refractive index of air, an actual distance therebetween can be obtained. In this case, a distance between the reference plane 41 of the optical component 4 and each position in the longitudinal direction of the light receiving region 6A formed on the surface SS of the sample S can be obtained. Thus, by subtracting a distance between the periphery of the hole SH and the reference plane 41 from a distance between the bottom surface of the hole SH of the sample S and the reference plane 41, the depth of the hole SH can be obtained.

Note that, in the above description, the FFT method is used to calculate the optical distance based on the reflection spectrum. However, another calculation method may be used. For example, a curve fitting method or a peak valley method may be used.

FIG. 7 is a diagram illustrating an example of a mechanical configuration of the profile measurement system 1. The profile measurement system 1 includes a support frame 11. The XY stage 13 for arranging the sample S thereon is mounted at a lower portion of the support frame 11. A measurement head 15 including the objective lens 3 is mounted at an upper portion of the support frame 11.

The XY stage 13 is configured to move in the horizontal direction in response to an instruction from the calculation unit 7. An image fiber 19 is mounted to the measurement head 15. Light from the light source 2 is guided to the objective lens 3 through the image fiber 19, and light received by the objective lens 3 is guided to the imaging spectrometer 6 through the image fiber 19.

In addition, in this example, a support mechanism 17 for supporting the optical component 4 is arranged on the XY stage 13. The support mechanism 17 is arranged on the XY stage 13 so as to protrude upward from the periphery of the sample S. The optical component 4 is arranged on the support mechanism 17 so as to cover the sample S from above.

FIG. 8 is a diagram illustrating another example of the mechanical configuration of the profile measurement system 1. The configurations common to the example of FIG. 7 are denoted by the same reference symbols to omit detailed descriptions thereof.

In this example, a support mechanism 18 for supporting the optical component 4 is arranged on the support frame 11. The support mechanism 18 is arranged to have an arch shape so as to be bridged above the sample S and the XY stage 13. The optical component 4 is supported by the support mechanism 18 above the sample S.

In the examples of FIGS. 7 and 8, the optical component 4 is supported above the sample S so that the reference plane 41 of the optical component 4 may be opposed in proximity to the surface SS of the sample S. Accordingly, most of the optical path from the light source 2 to the imaging spectrometer 6 is common, and an optical path difference is generated depending on a clearance between the reference plane 41 of the optical component 4 and the surface SS of the sample S. Consequently, the influence of vibration can be suppressed as compared to the related art in which there are two relatively long optical paths.

Further, as illustrated in FIG. 7, when the support mechanism 17 for the optical component 4 is arranged on the XY stage 13, even if vibration is applied to the support frame 11 or the like, the sample S and the optical component 4 are vibrated similarly, and hence the distance between the surface SS of the sample S and the reference plane 41 of the optical component 4 is less liable to vary, which is preferred for suppressing the influence of vibration.

Further, as illustrated in FIG. 8, when the support mechanism 18 for the optical component 4 is arranged on the support frame 11, the optical component 4 is prevented from moving in the in-plane direction, and hence the optical component 4 only needs to be located below the measurement head 15, which is preferred in view of downsizing of the optical component 4.

Note that, the support mechanisms 17 and 18 illustrated in FIGS. 7 and 8 are each capable of adjusting the height of the optical component 4 to change the distance between the reference plane 41 of the optical component 4 and the surface SS of the sample S. This function is used in an example to be described below.

Now, a description is given of an example where a measurement target is a sample having a thin film formed on at least a part of its surface.

For example, in a semiconductor chip to be subjected to the formation of TSV, a resist film may be formed at the periphery of the hole in a manufacturing process. In this case, an unintended resist film may be formed inside the hole as well, and the resist film may remain without being completely removed. To address this, demands have been made on a technology of determining whether or not a resist film remains inside a hole.

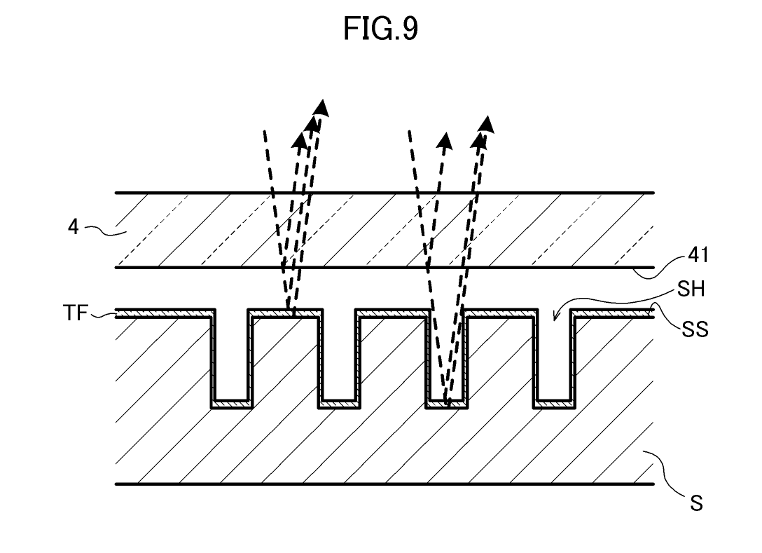

To respond to the demands, in the example to be described below, as illustrated in FIG. 9, a sample S having a transmissive thin film TF formed on a surface SS thereof is used as a measurement target, and the profile of the surface SS and the thickness of the thin film TF are calculated based on a measured reflection spectrum.

Part of light that has been transmitted through the reference plane 41 of the optical component 4 is reflected by the surface of the thin film TF, and the remaining part is transmitted through the surface of the thin film TF and reflected by the surface SS of the sample S (in other words, the periphery of the hole SH or the bottom surface thereof). Accordingly, the light reflected by the reference plane 41 of the optical component 4, the light reflected by the surface of the thin film TF, and the light reflected by the surface SS of the sample S interfere with one another.

Based on the calculated reflectance spectrum, the calculation unit 7 calculates a distance between the reference plane 41 of the optical component 4 and the surface SS of the sample S and a thickness of the thin film TF formed on the surface SS of the sample S.

More specifically, based on the calculated reflectance spectrum, the calculation unit 7 calculates a distance between each position in the longitudinal direction of the linear light receiving region 6A (see FIG. 2) formed on the surface SS of the sample S and the reference plane 41 and a thickness of the thin film TF formed at each position in the longitudinal direction of the light receiving region 6A.

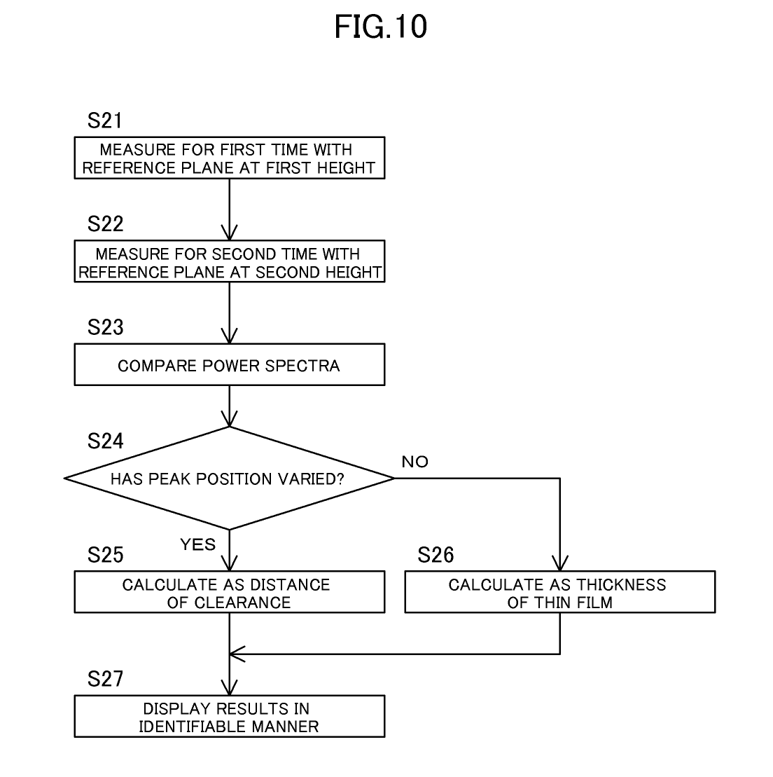

FIG. 10 is a flowchart illustrating a measurement procedure when the measurement target is the sample S having the thin film TF formed on the surface SS.

First, a reflection spectrum is measured for the first time with the reference plane 41 at a first height (S21). Specifically, the support mechanism 17 or 18 (see FIG. 7 or 8) that supports the optical component 4 is adjusted so that the reference plane 41 has the first height, and in this state, spectrum data of the sample S is acquired as described above. Then, the spectrum of reflectance is calculated, and FFT analysis is performed.

Next, a reflection spectrum is measured for the second time with the reference plane 41 at a second height (S22). Specifically, the support mechanism 17 or 18 that supports the optical component 4 is adjusted so that the reference plane 41 has the second height larger than the first height, and in this state, spectrum data of the sample S is acquired as described above. Then, the spectrum of reflectance is calculated, and FFT analysis is performed.

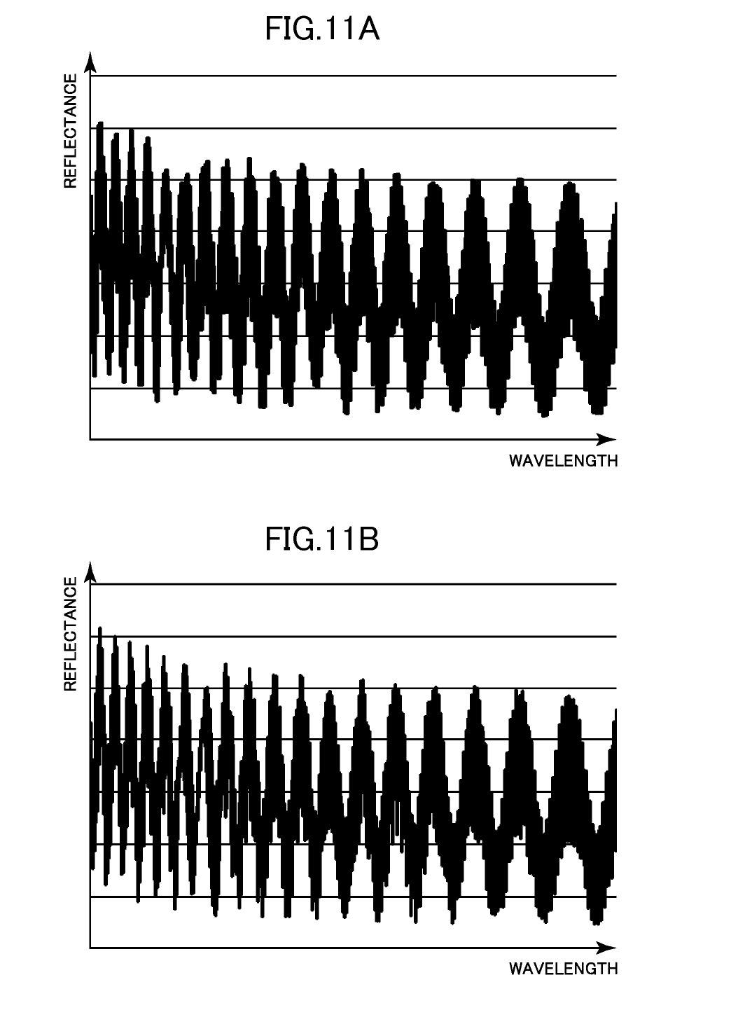

In this manner, two reflectance spectra measured with different distances can be obtained. FIGS. 11A and 11B are graphs showing examples of two reflectance spectra. Because the distance between the reference plane 41 of the optical component 4 and the surface SS of the sample S is changed, the periodicities of the two reflectance spectra are changed.

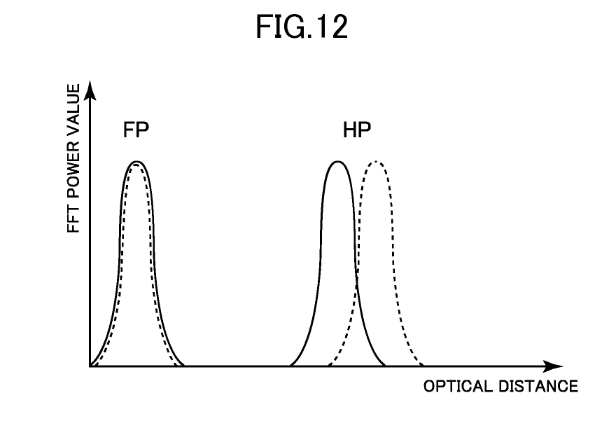

Next, power spectra are compared (S23). FIG. 12 is a graph showing an example of an analysis result obtained by FFT analysis of two reflectance spectra. One of the power spectra is represented by the solid line, and the other power spectrum is represented by the broken line. Comparing the two power spectra, there are a peak HP at which a peak position varies and a peak FP at which a peak position does not vary.

The peak HP at which the peak position varies is a peak of a frequency component derived from the distance between the reference plane 41 of the optical component 4 and the surface SS of the sample S. In other words, the peak position varies because measurement is performed with different distances between the reference plane 41 of the optical component 4 and the surface SS of the sample S.

On the other hand, the peak FP at which the peak position does not vary is a peak of a frequency component derived from the thickness of the thin film TF formed on the surface SS of the sample S. In other words, even when the distance between the reference plane 41 of the optical component 4 and the surface SS of the sample S is changed, the thickness itself of the thin film TF does not change, and hence the peak position does not vary.

Then, when each peak included in the FFT analysis result is the peak HP at which the peak position varies (S24: YES), this peak is identified as the peak of the frequency component derived from the distance between the reference plane 41 of the optical component 4 and the surface SS of the sample S (S25). When each peak included in the FFT analysis result is the peak FP at which the peak position does not vary (S24: NO), this peak is identified as the peak of the frequency component derived from the thickness of the thin film TF formed on the surface SS of the sample S (S26).

After that, the results of identifying the peaks are displayed in an identifiable manner (S27). For example, various kinds of peaks may be displayed on the display unit 8 with different colors or the like.

Note that, in the embodiment described above, two reflectance spectra measured with different distances are used to identify the kinds of peaks, but the identification method is not limited thereto. For example, the kinds of peaks can be identified based only on a single reflectance spectrum as long as the range where the peak of the frequency component derived from the distance between the reference plane 41 of the optical component 4 and the surface SS of the sample S appears and the range where the peak of the frequency component derived from the thickness of the thin film TF formed on the surface SS of the sample S appears are known and are not overlapped with each other.

While the embodiment of the present application has been described above, it is to be understood that the present invention is not limited to the embodiment described above and may be subjected to various modifications by a person skilled in the art.

What is claimed is:

1. A profile measurement system, comprising:
a transmissive optical component having a reference plane opposed to a surface of a sample;
a light source which irradiates the surface of the sample with light having a predetermined wavelength region through the transmissive optical component;
an imaging spectrometer which measures a reflection spectrum for each position on a linear region defined on the surface of the sample; and
a calculation unit which calculates a distance between each position on the linear region and the reference plane based on the measured reflection spectrum for each position on the linear region.

2. The profile measurement system according to claim 1, further comprising:
a field stop for limiting a region to be irradiated with the light to a region corresponding to the linear region.

3. The profile measurement system according to claim 1, further comprising:
a mechanism configured to support the optical component, the mechanism being arranged on a stage on which the sample is arranged.

4. The profile measurement system according to claim 1, further comprising:
a mechanism configured to support the optical component, the mechanism being arranged on a support frame supporting a measurement head configured to receive light reflected from the sample and a stage on which the sample is arranged.

5. The profile measurement system according to claim 1,
wherein the sample has a thin film formed on at least a part of the surface thereof, and
wherein the calculation unit is configured to calculate, based on the reflection spectrum measured for each position on the linear region, the distance between each position on the linear region and the reference plane and a thickness of the thin film at each position on the linear region.

6. The profile measurement system according to claim 5, further comprising:
an adjustment mechanism configured to adjust a distance between the surface of the sample and the reference plane,
wherein the calculation unit is configured to identify, based on a plurality of reflection spectra measured with different distances, a frequency component derived from the distance between the surface of the sample and the reference plane and a frequency component derived from the thickness of the thin film.

7. A profile measurement method, comprising:
irradiating a surface of a sample with light having a predetermined wavelength region through a transmissive optical component having a reference plane to be opposed to the surface of the sample;
measuring, by an imaging spectrometer, a reflection spectrum for each position on a linear region defined on the surface of the sample; and
calculating a distance between each position on the linear region and the reference plane based on the measured reflection spectrum for each position on the linear region.
